(19) United States
(12) Patent Application Publication
(10) Pub. No.: US 2009/0295307 A1
(43) Pub. Date: Dec. 3, 2009

(54) Inspection lamp with buck boost circuit control

(75) Inventors: John Duerr, Massapequa Park, NY (US); Gustavo Garcia, East Setauket, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Spectronics Corporation

(21) Appl. No.: 12/454,970

(22) Filed: May 26, 2009

Related U.S. Application Data
(60) Provisional application No. 61/130,274, filed on May 28, 2008.

(51) Int. Cl. H05B 37/02; F21L 4/00

(52) U.S. Cl. 315/294; 362/157; 362/183

(57) ABSTRACT

A lamp for fluorescent inspection having a housing with a first end and a second end. The first end includes a head having at least one LED which emits light with a wavelength designed to excite a material so as to produce fluorescence. The switch controls power the a circuit within the housing for powering the at least one LED. The circuit retards voltage when voltage exceeds a first threshold. In one embodiment the circuit boosts voltage when voltage drops below a second threshold, and blocks voltage when voltage drops below a third threshold.

### RELATED APPLICATION

This application is related to and claims priority from U.S. Provisional Application No. 61/130,274, filed May 28, 2008, the disclosure of which is incorporated herein by reference in its entirety.

### FIELD OF INVENTION

The present invention relates to lamps, and especially, but not exclusively, to a lamp for handheld use in leak detection and/or non destructive testing.

### BACKGROUND

Fluorescence is generally understood to be a property that enables certain materials to absorb light energy and radiate visible light at a longer wavelength than the absorbed light. Without being limited to any specific theory, it is widely accepted that electrons in fluorescent materials are excited upon being illuminated by light energy of a specific wavelength, and light energy of a longer wavelength is radiated from these materials as the electrons return to the unexcited or ground state. The specific excitation and radiation wavelengths are characteristics of the particular fluorescent materials. The apparent brightness of a fluorescent material's luminescence is dependent, among other factors, on the wavelength emitted by the material and the intensity of the incident radiation that excites the material. A fluorescent material that has its excitation peak at a specific wavelength may quickly emit a much reduced luminescence as the wavelength of incident light deviates from the excitation peak, and will lose the ability to fluoresce when the incident light does not have enough energy within the specific excitation range.

Lamps emitting radiation that excites fluorescence have been used for a wide variety of purposes, including, but not limited to, forensic inspection, readmission control, counterfeit currency detection, contamination inspection, non-destructive testing, and detecting leaks in air conditioning and other fluid-containing systems. The lamplight is commonly in the ultraviolet (UV) or in the visible blue-violet range, exciting a fluorescence somewhere in the visible range. The fluorescent material may be deliberately provided. For example, some banknotes have a fluorescent marker embedded in the paper and the lamplight is used to detect the otherwise hidden marker. In another example, one method for detecting leaks in an air conditioning system is through the use of fluorescent dyes that are added to and mixed with the refrigerant in the system, with the combination of refrigerant and dye circulating through the air conditioning system. This method was first pioneered by Spectronics Corporation, the assignee of the present invention. In these leak detection systems, the dye circulates through the system, eventually seeping out at the source of the leak. When exposed to a suitable light source, such as a UV or blue-violet light, the dye fluoresces, thus highlighting the source of the leak.

The visibility of the fluorescent response is increased when the intensity of other visible light is reduced, so that the fluorescent response is not masked or washed-out by other light. Thus, UV or blue-violet lamps directed in otherwise dark conditions at a system containing a UV or blue-violet responsive fluorescent material may reveal the fluorescent material glowing against the dark background.

For many purposes, a battery operated hand-held lamp that can be directed at less-accessible areas is desirable. Existing lamps powered by an external AC or DC power source have a trailing power lead that hinders maneuvering of the lamp, and cannot be used where a suitable power source is not available. Many existing battery powered lamps are heavy and bulky. The size and shape of the lamp typically hinders maneuvering of the lamp, makes the lamp awkward to grasp in the hand, or both. Small lamps do exist, for example, the UV-4B Series battery operated ultraviolet lamps manufactured and sold by Spectronics Corporation are only about 16 cm long by 2.5 cm wide by 5 cm from front to back. Those lamps are deep from front to back, with the actual light source positioned along one narrow side of the lamp unit. U.S. Pat. No. 6,491,408 discloses another type of handheld inspection lamp.

A problem with smaller, hand-held lamps with light emitting diodes (LEDs) is that LEDs can overheat when voltage exceeds their design voltage. Many hand-held lamps are powered by rechargeable batteries. When rechargeable batteries are recharged, they can become more powerful, with recharged voltages reaching about 5.0 volts. If, for example, the capacity of an LED is 4.6 volts, if the voltage supplied by the battery is not controlled, overheating of the LEDs will occur. Many visible light LEDs are relatively low in cost. As such, there is limited concern if the LEDs overheat. However, inspection lamps that are designed to cause fluorescent materials, such as dyes, to become excited and fluoresce use UV or true blue LEDs. Those types of LEDs are very expensive. Thus, the Applicants have determined that the likelihood of overheating of the LEDs must be controlled.

A need, therefore, exists for an inspection lamp that is compact, easy to hold, provides for efficient use of batteries, especially rechargeable batteries, or other supplied power and prevents the lamp from overheating.

### SUMMARY OF INVENTION

The present invention relates to a lamp for fluorescent inspection, such as leak detection The lamp includes a lamp having a housing with a first end and a second end. The first end includes a head having at least one and preferably a plurality of chambers for LEDS, for example, three or four chambers. Each chamber preferably includes at least one LED surrounded by a reflective surface and a window through which the at least one LED can emit light. A switch is mounted to the housing and connected to a circuit. The switch controls the circuit and thus the supply of power from a power source. In one embodiment, the power source is one or more batteries and the second end includes a receptacle for holding the batteries. The circuit retards voltage to the at least one LED when voltage from the power source exceeds a first threshold, boosts voltage to the at least one LED when voltage from the power source drops below a second threshold, and blocks voltage to the at least one LED when voltage from the power source drops below a third threshold.

### BRIEF DESCRIPTION OF THE DRAWINGS

For the purpose of illustrating the invention there is shown in the drawings various forms which are presently preferred; it being understood, however, that this invention is not limited to the precise arrangements and instrumentalities particularly shown.

FIG. 1 shows a perspective view of an embodiment of a lamp.

FIG. 2 shows a plan view of a head of the lamp of FIG. 1.

FIG. 3 shows a diagram of the circuitry in the lamp of FIG. 1 for controlling the voltage supplied to the LEDs.

### DETAILED DESCRIPTION OF THE PREFERRED EMBODIMENTS

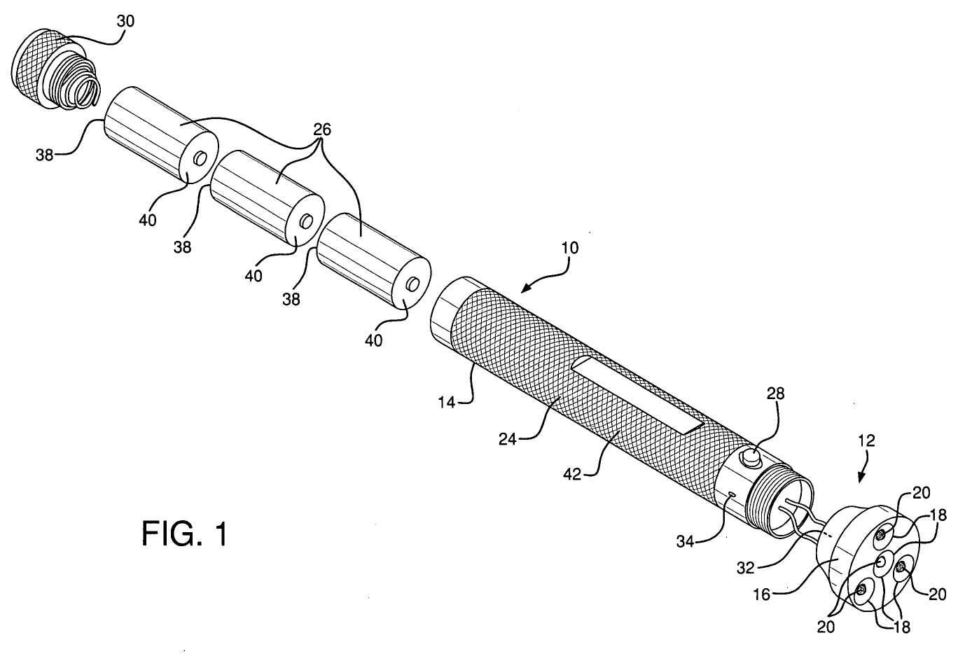

FIG. 1 shows a lamp 10 having a first end 12 and a second end 14. The first end 12 includes a head 16 having at least one and preferably a plurality of chambers 18. Each chamber 18 includes at least one LED 20 surrounded by a reflective surface 22 and a window through which the at least one LED 20 can emit light.

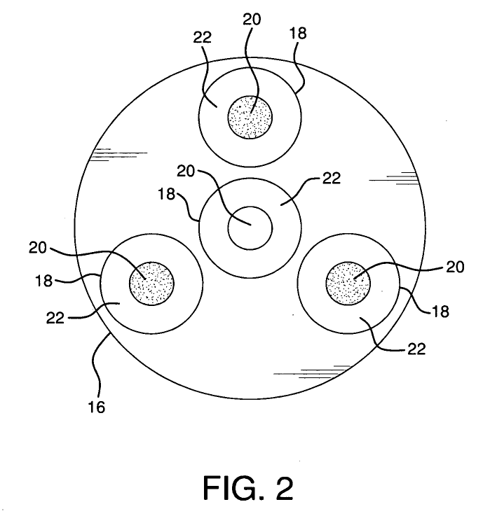

As shown in FIGS. 1 and 2, the head 16 preferably has four chambers 18. Three of the chambers 18 each include a single non-white LED 20. Preferably, the non-white LEDs are UV or blue LEDs for facilitating fluorescent inspection. The fourth chamber includes a single white LED 20. It is contemplated that each chamber 18 can include more than one LED 20 or that more or less chambers may be included.

All four of the chambers 18 have a tapered reflective surface 22 to aid in reflecting the light from the LEDs 20. The reflective surface 22 focuses the light from the LEDs 20 while at the same time minimizing loss of light due to absorption of the light waves by the chambers 18. The reflective surface can be made from any reflective material such as mirrors, glass, reflective metals, reflective plastics, a reflective coating, or the like. While the preceding discussion refers to the lamp as including a reflective chamber, it is also contemplated that the LEDs may simply be mounted on a flat surface and surrounded by a focused lens.

To further assist in transmitting the light, the chambers 18 can be in various orientations that allow the light to be reflected away from the chambers. For example, the chambers 18 can have a concave shape.

The windows on the chambers 18 are preferably made from a durable, transparent material so that the LEDs 20 are protected, but the light emitted from the LEDs 20 is not impeded. For example, windows can be made from plexiglass, glass, and other similar materials. Preferably, a single transparent window covers all the chambers. It is also contemplated that the window may be a lens to focus the light emitted from the LEDs.

The second end 14 of the lamp 10 includes a receptacle 24 for holding one or more batteries 26 and functions as a handle for the lamp.

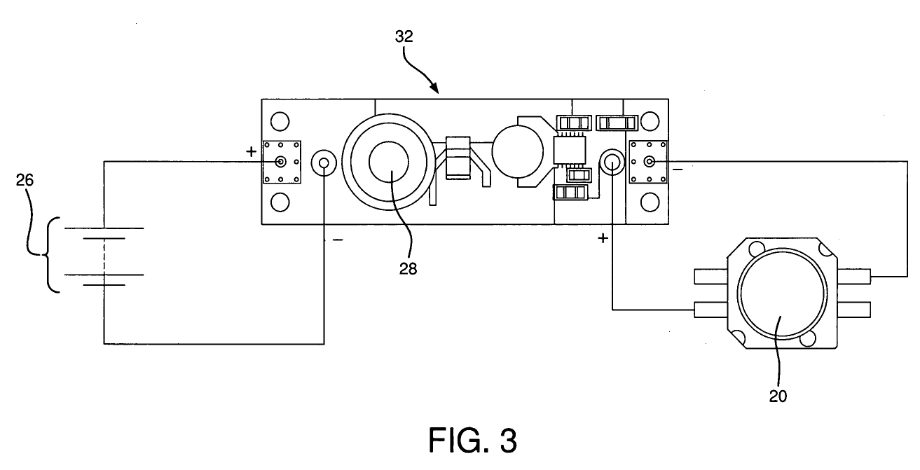

The second end 14 includes a button 28 controlling the at least one LED 20. As shown in FIG. 3, the button 28 and the one or more batteries 26 are in communication with a circuit 32 within the lamp 10 for powering the at least one LED 20. The circuit can be located in the first end 12 or the second end 14.

The button 28 is configured to act as a switch for the circuit 32, allowing the circuit 32 to operate through various stages. Starting in an “off” position (i.e., no power is provided to any of the LEDs shown in FIGS. 1 and 2), pressing the button 28 once takes the circuit 32 into a first stage. In the first stage, power is provided to the three non-white LEDs 20. In a second stage, which is achieved by pressing the button 28 a second time, the circuit 32 is returned to the “off” position. In a third stage, which is achieved by pressing the button 28 a third time, the one or more batteries 26 provide power to the at least one white LED 20. Pressing the button 28 a fourth time, the circuit 32 is returned to the “off” position, with no power being supplied to the non-white LEDs 20 or to the white LED 20. The switch may be any conventional switch including a pushbutton, toggle or dial.

Other variations of the staging are also within the scope of the invention. For example, at stage one, power could be provided to the white LED 20; at stage two, power could be provided to the three non-white LEDs 20; at stage three, power could be provided to the at least one white LED 20 and the three non-white LEDs 20; and at stage four, power could be turned off.

In another example of contemplated staging, in a first stage of the circuit 32, power is supplied to at least one of the LEDs 20 from the one or more batteries 26; in a second stage of the circuit 32, power is supplied to some but not all of the non-white LEDs 20 from the one or more batteries 26; and in a third stage of the circuit 32, no power is provided to the LEDs 20. The particular staging desired can be accomplished by a person skilled in the art by adjusting the configuration of the circuit.

Preferably the circuit 32 includes a buck boost controller. The buck boost controller provides an output voltage to the at least one LED 20 that can be less than or greater than the input voltage from the one or more batteries 26. The buck boost controller can be obtained by a cascade connection of two basic converters: a step down (buck) converter and a step up (boost) converter. With the buck boost controller, the circuit 32 can retard or boost the voltage to the at least one LED 20.

The circuit 32 retards voltage to the at least one LED 20 when voltage from the one or more batteries exceeds a first threshold. In one embodiment, the first threshold can be from about 3.6 volts to about 5.6 volts. Preferably, the first threshold is about 4.6 volts.

The circuit 32 boosts voltage to the at least one LED 20 when voltage from the one or more batteries drops below a second threshold. In one embodiment, the second threshold can be from about 2.0 volts to about 4.8 volts. Preferably, the second threshold is about 3.8 volts.

The circuit 32 blocks voltage to the at least one LED 20 when voltage from the one or more batteries drops below a third threshold. In one embodiment, the third threshold can be from about 1.2 volts to about 4.6 volts. Preferably, the third threshold is about 2.8 volts.

The second end 14 includes an end cap 30 that is removably attachable to the receptacle 24. The end cap 30 keeps the batteries 26 securely in place when the end cap 30 is attached to the receptacle 24. The end cap also provides for a snug fit of the batteries 26 in the receptacle 24 to ensure that proper contacts are made between the batteries and between the batteries and the circuit. As shown in FIG. 1, the snug fit is provided for by a spring 36 on the end cap 30. The spring allows for the batteries 26 to be placed into the receptacle 24 and then secured when the end cap 30 is secured onto the receptacle 24.

The receptacle 24 is structured so that one or more batteries 26 can be housed inside the second end. The receptacle 24 shown in FIG. 1 preferably houses three “C”-sized batteries 26. All three batteries 26 are oriented in the same direction having their negative ends 38 facing the end cap 30 and their positive ends facing the first end 12. Alternatively, more or less batteries and different size batteries can be used. It is also contemplated that a rechargeable battery can be included in the receptacle, instead of the disposable batteries. In the event a rechargeable battery is used, a plug socket may be formed in the second end for receiving a plug from an AC or DC charger.

The second end 14 optionally includes an indicator light 34. The indicator light 34 can be used to indicate when the one or more batteries 26 are properly charge. For example, if the voltage of the one or more batteries 26 exceeds the second threshold, the indicator light 34 can show green. If the voltage of the one or more batteries 26 drops below the second threshold, but is still above the third threshold, the indicator light 34 can show yellow, indicating that the battery level is low but the batteries are still usable. If the voltage of the one or more batteries 26 drops below the third threshold, the indicator light 34 can show red, indicating that the batteries should be replaced. Alternatively, the indicator light 34 can be used to show only one of these states. For example, the indicator light can be used to show only that the one or more batteries 26 need to be replaced.

The first end 12 and second end 14 can be made from the same material. For example, the first end 12 and second end 14 can be made from aluminum, aluminum alloy, titanium, titanium alloy, stainless steel, PVC, HDPE, and other similar materials. Alternatively, the material of construction for the first end 12 can be different from the material of construction for the second end 14. For example, the first end 12 may be made from aluminum, while the second end is made from HDPE.

The second end 14 also includes a textured area 42 that provides the user with a gripping area to lessen the ability of the lamp 10 to slip from the user's hand. The textured area 42 can include grooves on the outer surface of the receptacle 24, raised sections on the outer surface of the receptacle 24, or a combination of both. The grooves and/or raised sections can be made from the same material as or formed in the receptacle 24. Alternatively, the grooves and/or raised sections can be made from a material that is different than the receptacle 24. For example, the receptacle 24 may be made from aluminum, while the textured area 42 is made from rubber.

The grooves and/or raised sections can be oriented in any desired direction, such as (i) parallel to the length-wise axis of the lamp 10; (ii) perpendicular to the length-wise axis of the lamp 101; or (iii) at an acute angle relative to the length-wise axis of the lamp 10. The grooves and/or raised sections can be oriented in a uniform pattern (e.g., parallel lines, crisscross pattern) or can be randomly oriented.

Although the above discussion has related to the use of a battery power source, it is also contemplated that the power to the LEDs might be provided by line (direct AC power). The present invention can be easily tailored to such a configuration.

It is also contemplated that the system may be designed so as to only provide the buck aspect of the invention (i.e., prevent overheating of the LEDs without boosting the voltage.

It will be appreciated by those skilled in the art, that the present invention may be practiced in various alternate forms and configurations. The previously detailed description of the disclosed embodiments is presented for purposes of clarity of understanding only, and no unnecessary limitations should be implied there from.

We claim:

1. A lamp for fluorescent inspection, with at least one LED which emits light with a wavelength designed to excite a material so as to produce fluorescence, the inspection lamp comprising:
a housing having a first end and a second end;
the first end comprising a head, at least one light emitting diode and a window through which the at least one light emitting diode can emit light;
a switch mounted on the housing, the switch in communication with a circuit within the housing for powering the at least one light emitting diode; and a power source for supplying power to the circuit;
wherein the circuit retards voltage to the at least one light emitting diode when voltage from the power source exceeds a first threshold.

2. A lamp of claim 1, wherein the circuit boosts voltage to the at least one light emitting diode when voltage from the one or more batteries drops below a second threshold, and blocks voltage to the at least one light emitting diode when voltage from the one or more batteries drops below a third threshold.

3. A lamp of claim 1, wherein the power source is one or more batteries, and wherein the second end includes a receptacle for holding the batteries, and a removably attachable end cap.

4. A lamp of claim 1, wherein there are a plurality of light emitting diodes, each mounted within a chamber and surrounded by a reflective surface.

5. A lamp of claim 1, wherein the power source is a power cord for supplying line voltage from an external AC outlet.

6. A lamp of claim 1, wherein the circuit comprises a buck boost control circuit.

7. A lamp of claim 6, wherein the buck boost control circuit comprises a cascade connection of a step down converter and a step up converter.

8. A lamp of claim 2, wherein the first threshold is about 4.6 volts.

9. A lamp of claim 2, wherein the second threshold is about 3.8 volts.

10. A lamp of claim 2, wherein the third threshold is about 2.8 volts.

11. A lamp of claim 2, further comprising an indicator light.

12. A lamp of claim 11, wherein the indicator light is lit when the voltage drops below the third threshold.

13. A lamp of claim 4, wherein there are four light emitting diodes.

14. A lamp of claim 13, wherein the switch is configured as a switch for the circuit where, in a first stage of the circuit, power is supplied to at least one of the light emitting diodes from the power source, in a second stage of the circuit, power is supplied to at least three of the light emitting diodes from the power source, and in a third stage of the circuit, no power is provided to the light emitting diodes.

15. A lamp of claim 13, wherein a single UV light emitting diode is present in three of the chambers.

16. A lamp of claim 15, wherein a single white light emitting diode is present in one of the chambers.

17. A lamp of claim 16, wherein the UV light emitting diodes are illuminated in a first stage of the circuit and the white light emitting diode is illuminated in a second stage of the circuit.

18. A lamp of claim 3, wherein the one or more batteries are rechargeable batteries.
